(19) United States
(12) Patent Application Publication
(10) Pub. No.: US 2016/0146265 A1
(43) Pub. Date: May 26, 2016

(54) FRICTION SURFACE

(71) Applicant: SCHAEFFLER TECHNOLOGIES AG & CO. KG, Herzogenaurach (DE)

(72) Inventors: Oliver Runge, Alt-Windeck (DE); Stefan Lohr, Mudenbach (DE)

(73) Assignee: Schaeffler Technologies AG & Co.KG, Herzogenaurach (DE)

(21) Appl. No.: 14/904,259

(22) PCT Filed: Jul. 2, 2014
(86) PCT No.: PCT/DE2014/200295

§ 371 Date: Jan. 11, 2016

(30) Foreign Application Priority Data
Jul. 9, 2013 (DE) 10 2013 213 371.5

(51) Int. Cl. F16D 13/64; F16D 69/00

(52) U.S. Cl. CPC F16D 13/64; F16D 69/00

(57) ABSTRACT

The invention concerns a friction surface (41) of a stationary clutch and/or braking arrangement which is provided with raised portions (11, 12, 13, 14, 15, 16, 17, 18) and/or depressions.

### BACKGROUND

The invention relates to a friction surface of a stationary clutch and/or braking arrangement. The invention further relates to a friction surface of a stationary clutch and/or braking arrangement with at least one such friction surface. The invention furthermore relates to a stationary clutch and/or braking arrangement comprising such a friction surface. The invention finally relates to a rotor for a stationary clutch and/or braking arrangement, particularly a clutch comprising at least one such friction surface.

A carbide-ceramic contact body is known from the German patent publication DE 10 2006 044 858 A1, which is used for example in elevator brakes. A friction brake is known from the German patent publication DE 10 2011 000 720 A1 for braking a rail-guided transportation device, particularly an elevator, comprising at least one brake coating, a tensioning device, by which at least one brake coating can be pressed against a rail in order to brake the transportation device, and an actuator for operating a tensioning device. From the international patent publication WO 2013/030457 A2 a friction brake is known, which is embodied like a caliper, such as potentially used for braking elevators, for example.

### SUMMARY

The objective of the invention is to improve the operating behavior of stationary clutch and/or braking arrangements.

The objective is attained in a friction surface of a stationary clutch and/or braking arrangement such that the friction surface is provided with raised portions and/or depressions. The friction surface is preferably embodied as an annular surface with an interior diameter and an exterior diameter. By the raised portions and/or depressions any undesired wear and tear of the friction surface can be considerably reduced in a simple fashion.

A preferred exemplary embodiment of the friction surface is characterized in that the friction surface is provided with grooves. The grooves may be rounded at the bottom or exhibit sharp edges. The depth of the grooves is preferably adjusted to the expected wear and tear over an intended life span.

Another preferred exemplary embodiment of the friction surface is characterized in that the grooves extend in radial directions. The term radial refers to an axis of rotation of an essentially annular friction surface during operation. Radial represents a direction perpendicular to the axis of rotation.

Another preferred exemplary embodiment of the friction surface is characterized in that the grooves extend in directions, which are arranged at an angle up to 45 degrees in reference to the radial direction. This arrangement has proven advantageous with regards to minimizing any wear and tear developing during operation.

Another preferred exemplary embodiment of the friction surface is characterized in that the grooves exhibit a groove width, which measures from 0.5 to 6 millimeter. This groove width has proven particularly advantageous in examinations performed within the scope of the present invention.

Another preferred exemplary embodiment of the friction surface is characterized in that at least six grooves are evenly distributed in a circumferential direction. This number has proven particularly advantageous in experiments performed within the scope of the present invention.

Another preferred exemplary embodiment of the friction surface is characterized in that the friction surface includes at least one annular groove. The annular groove may be provided alternatively or additionally to the grooves, which extend essentially in radial directions.

The invention relates furthermore to a friction surface of a stationary clutch and/or braking arrangement with at least one above-described friction surface. The friction surface may be designed like friction surfaces of stationary clutch and/or braking arrangements of prior art or similar thereto. Unlike the stationary clutch and/or braking arrangements of prior art the friction surface according to the invention is however provided with grooves.

The invention relates further to a stationary clutch and/or braking arrangement with an above-described friction surface. The clutch or braking arrangement is preferably embodied as a clutch coupling. The clutch coupling comprises for example a rotary interior part with two essentially annularly friction surfaces, which are provided with grooves according to an essential aspect of the invention.

The invention relates further to a rotor for a stationary clutch and/or braking arrangement, particularly a clutch coupling comprising at least one above-described friction surface. The rotor with the friction surface according to the invention is preferably provided with internal gears, however optionally it may also be provided with external gears. Here, the rotor may optionally be made completely from a friction material. The friction material may however also be applied at both sides on a carrier element in order to form the rotor. The carrier element may be formed from a metallic material or from a fibrous composite.

The invention can also relate to a technical conveyance system comprising an above-described stationary clutch and/or braking arrangement. The conveyance system is for example embodied as a crane, hoist, elevator, or escalator.

The invention relates to the use of a friction surface with raised portions and/or depressions, particularly with grooves, as known for example from automotive technology, in a stationary clutch and/or braking arrangement. In the automotive field the embodiment of friction surfaces with grooves in the friction surface is known for example from the German patent publication DE 196 26 688 A1. Here, the grooves in the automotive sector are primarily inserted for the purpose of avoiding separation problems due to vacuum effects.

Experiments performed within the scope of the invention at stationary clutch and/or braking arrangements, particularly clutch couplings, showed relatively high wear and tear rates in un-grooved friction surfaces of prior art. The reason for the elevated wear and tear is assumed, within the scope of the present invention, in that during the input of energy in the boundary area at least small pieces and/or thin layers of the friction material separate from the friction surface and deposit on the metallic counter surface or surfaces of the braking and/or clutch device. In a following energy input then the friction material, particularly of a rotor, travels partially towards the friction material adhered on the counter rotor. This form of friction can very quickly lead to undesired disorganization and/or high wear and tear of the friction material. The introduction of grooves according to the invention in un-grooved friction surfaces of prior art surprisingly increases the permitted energy limit and/or reduces the wear and tear of the friction material at energy loads at the boundary in case of identical energy.

### BRIEF DESCRIPTION OF THE DRAWINGS

Additional advantages, features, and details of the invention are discernible from the following description, in which different embodiments are described in detail with reference to the drawings. Here, shown are:

FIG. 1 an exemplary embodiment of a friction surface with diagonally extending grooves in a friction surface;

FIG. 2 a groove of the friction surface of FIG. 1 in a cross-section;

FIG. 3 an exemplary embodiment of a friction surface with radially extending grooves in a friction surface, and

FIG. 4 a groove of the friction surface of FIG. 3 in a cross-section.

### DETAILED DESCRIPTION OF THE PREFERRED EMBODIMENTS

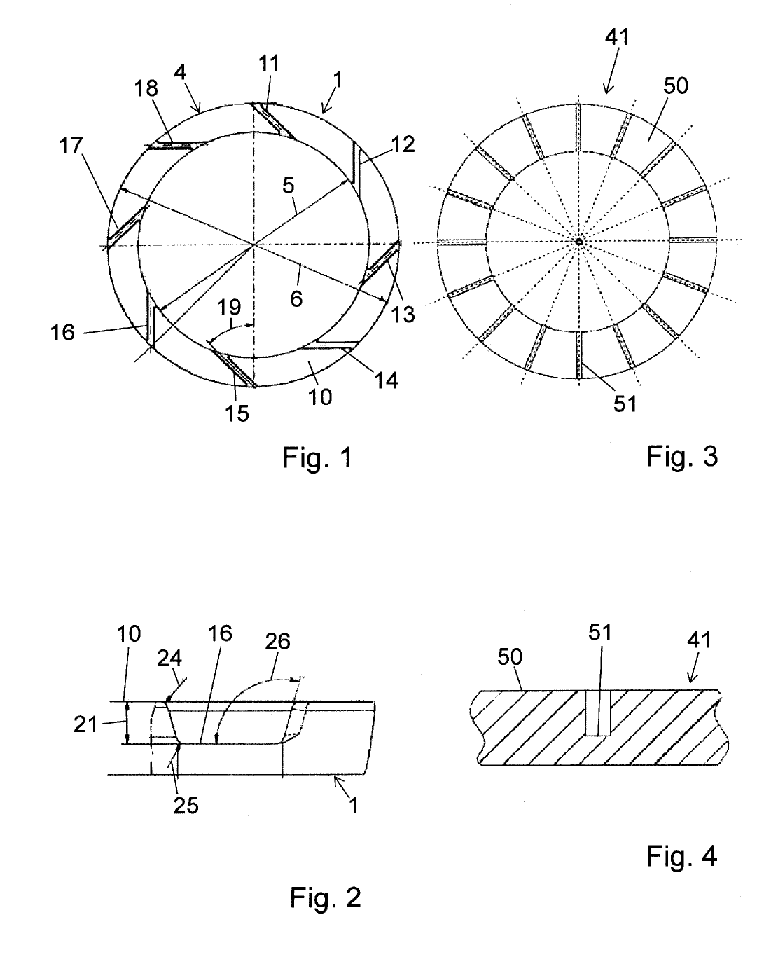

FIG. 1 shows a friction surface 1 in the form of an annular disk 4 in a top view. A double arrow 5 indicates an interior diameter of the annular disk 4. Another double arrow 6 indicates an exterior diameter of the annular disk 4.

It is discernible from the top view of FIG. 1 that the friction coating 1 has a friction surface 10, in which a total of eight grooves 11 to 18 are inserted. The grooves 11 to 18 are evenly distributed over a circumference of the friction surface 10. Here, the grooves are arranged at an angle of approximately forty five degrees in reference to a radial, as indicated by a double arrow 19.

By inserting the grooves 11 to 18 into the friction surface 10 of the friction coating 1 the area of the annular disk 4, shown in FIG. 1, is divided into several small sections. Experiments performed within the scope of the present invention have shown that the trend of such a divided friction coating 1 to transfer material to a counter rotor is considerably lower and thus the energy limit of an aggregate equipped with the friction coating 1 can be increased.

This way, at a predetermined switching energy a considerably lower wear and tear rate of the friction material can be yielded. By the grooves according to the invention any undesired adhesion and/or transfer of friction material to the counter rotor can surprisingly be securely prevented.

In FIG. 2 the groove depth of the groove 16 is indicated by a double arrow 21. The groove depth is at least as deep as an expected axial wear and tear of the friction coating 1 over the intended life span. The groove width amounts approximately to one millimeter in the exemplary embodiment shown.

An arrow 24 indicates that the transfer between the friction surface 10 and the groove 16 is rounded. An arrow 25 indicates that the groove 16 is also rounded at the groove bottom. The double arrow 26 indicates that the groove flanks of the groove 16 are arranged at an angle of one hundred five degrees in reference to the groove bottom.

FIG. 3 shows a friction coating 41 with a friction surface 50 in a top view. The friction coating 41 shows the form of an annular disk with an interior diameter and an exterior diameter. A total of sixteen grooves 51 are inserted in the friction surface 50. All grooves 51 are arranged in the radial direction.

In FIG. 4 it is discernible that the grooves 51 exhibit a rectangular cross-section. The grooves 51, similar to the grooves 11 to 18 of the friction coating 1 shown in FIG. 1, may be inserted for example by impression into the friction surface 10; 50.

### LIST OF REFERENCE CHARACTERS

1 friction coating
4 annular disk
5 double arrow
6 double arrow
10 friction surface
11 groove
12 groove
13 groove
14 groove
15 groove
16 groove
17 groove
18 groove
19 double arrow
21 double arrow
24 arrow
25 arrow
26 double arrow
41 friction coating
50 friction surface
51 grooves

1. A friction surface of a stationary clutch or braking arrangement, the friction surface includes at least one of raised portions or depressions.

2. The friction surface according to claim 1, wherein the depressions include grooves.

3. The friction surface according to claim 2, the grooves extend in radial directions.

4. The friction surface according to claim 2, the grooves extend in directions, which are arranged at an angle of up to 45 degrees in reference to a radial direction.

5. The friction surface according to claim 1, wherein the grooves have a groove width ranging from 0.5 to 6 millimeters.

6. The friction surface according to claim 3, wherein at least six of the grooves are evenly distributed in a circumferential direction.

7. The friction surface according to claim 1, wherein the depressions include includes at least one annular groove.

8. A friction surface of a stationary clutch or braking arrangement with at least one friction surface according to claim 1.

9. The stationary clutch or braking arrangement according to claim 8, wherein a friction coating forms the friction surface.

10. A rotor for a stationary clutch or braking arrangement, comprising at least one friction surface according to claim 1.
